(19) United States
(12) Patent Application Publication
(10) Pub. No.: US 2008/0046101 A1
(43) Pub. Date: Feb. 21, 2008

(54) Control Element, In Particular For A Vehicle

(75) Inventors: Konrad Klein, Stuttgart (DE); Bernhard Straub, Starzach (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/631,816

(22) PCT Filed: Jun. 22, 2005
(86) PCT No.: PCT/EP05/06725

§ 371 Date: Aug. 22, 2007

(30) Foreign Application Priority Data
Jul. 9, 2004 (DE) 10 2004 033 278.9

(51) Int. Cl. G05B 13/02

(52) U.S. Cl. 700/29

(57) ABSTRACT

A control element, in particular for a vehicle, is provided including a plurality of individual modules which change the shape of the control element as a function of the context. There are a plurality of degrees of freedom of adjustment which are enabled or disabled as a function of the control element context, it being possible to adapt the external shape of the control element to the enabled degrees of freedom of adjustment of the control element by raising and/or lowering at least one of the individual modules. The control element may be used, for example, in a motor vehicle operator control system.

### CROSS REFERENCE TO RELATED APPLICATION

This application is a National Stage of PCT International Application No. PCT/EP2005/006725, filed Jun. 22, 2005, which claims priority under 35 U.S.C. § 119 to German Patent Application No. 10 2004 033 278.9, filed Jul. 9, 2004, the entire disclosures of which are herein expressly incorporated by reference.

### BACKGROUND AND SUMMARY OF THE INVENTION

The present invention relates to a control element, in particular for a vehicle.

In contemporary vehicle operator control systems, menus and/or functions and/or functional values are controlled by operator controls being rotated, pushed, tilted, pressed, etc. The operator control elements used in these systems are generally shaped in such a way that they support just one type of adjustment movement in a way which is optimum and recognizable. For example, due to its shape, a rotary knob is suitable only for rotating and pressing, but not for pushing or tilting. However, for the sake of optimum operator control, different adjustment movements are necessary for specific operator control processes, for example, rotating for analog settings of volume, base, treble, etc. or pushing in four different directions in order to select alphanumeric characters, etc.

German patent document DE 197 31 285 A1 describes a control element for a device having a plurality of selectable menus, functions and/or function values. The shape of the touchable surface of the control element can be varied as a function of the context. The possible degrees of freedom of adjustment of the control element are permanently predefined, the control element being embodied either as a rotationally symmetrical rotary switch or as a touch pad whose surface is changed by lowering or raising planar and/or linear regions. The rotary switch may be pushed or rotated and only press the individual elements of the touch pad.

German patent document DE 199 04 070 A1 describes a lowerable switching element with a pop-out knob, the lowerable switching element being embodied as a joystick switch.

An object of the present invention is to provide a control element which can be adapted to various adjustment movements in order to increase the control element comfort and the operating reliability.

This and other objects and advantages are achieved by a control element (in particular for a vehicle) according to the present invention, in which the control element includes a plurality of degrees of freedom of adjustment that are enabled or disabled as a function of the control element context. The external shape of the control element may be adapted to the enabled degrees of freedom of adjustment of the control element by raising and/or lowering at least one individual module of the control element. As a result, the control element can advantageously be optimally adapted to the respective adjustment processes. Thus, intuitive activation of the control element is supported, because only those adjustment movements are possible which also correspond to the external shape of the control element and support of the associated control element process in an optimum way, which can be recognized by the user. The shape and the degrees of freedom of adjustment are predefined here by the control element context. The assignment of the degrees of freedom of adjustment to the control element context can be made adjustable, so that individual preferences can be taken into account.

In an exemplary embodiment of the control element, at least one individual module is raised in the positive z direction of an xyz coordinate system and lowered in the negative z direction of the xyz coordinate system.

In another exemplary embodiment of the control element, plurality of degrees of freedom of adjustment permit a rotational movement in the clockwise direction about the z axis of the xyz coordinate system, a rotational movement in the counterclockwise direction about the z axis of the xyz coordinate system, a horizontal sliding movement in a positive and/or negative x direction of the xyz coordinate system and a vertical sliding movement in the positive and/or negative y direction of the xyz coordinate system.

In another exemplary embodiment, the control element includes a central individual module and four identically shaped edge modules.

The individual modules of the control element are arranged, for example, such that the control element is mirror-symmetrical with respect to a vertical and/or horizontal central axis.

A first external shape of the control element can be adapted, for example, to the rotational movements of the control element. All of the individual modules of the control element may be raised from an initial position in the positive z direction into an end position, forming a round rotary actuator, the rotational movements of the control element being enabled and the vertical and horizontal sliding movements of the control element being disabled.

A second external shape of the control element can be adapted, for example, to the vertical sliding movements of the control element. The individual modules of the control element, which are arranged along the horizontal central axis, may be raised from the initial position in the positive z direction into the end position, forming a vertical sliding switch. The vertical sliding movements may be enabled, and the horizontal sliding movements and the rotational movements of the control element may be disabled.

A third external shape of the control element can be adapted, for example, to the horizontal sliding movements of the control element. The individual modules of the control element, which are arranged along the vertical central axis, may be raised from the initial position in the positive z direction into the end position, forming a horizontal sliding switch. The horizontal sliding movements may be enabled and the vertical sliding movements and the rotational movements of the control element may be disabled.

A fourth external shape of the control element can be, for example, simultaneously adapted to the horizontal and the vertical sliding movements of the control element. The central individual module of the control element may be raised from the initial position in the positive z direction into the end position, forming a four-direction switch. The horizontal and the vertical sliding movements may be enabled and the rotational movements of the control element may be disabled.

In a position of rest of the control element, for example, all of the individual modules are lowered into the initial position.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of individual modules of a control element according to the invention;

FIG. 2 is a schematic illustration of the individual modules in a position of rest of the control element according to the invention;

FIG. 3 is a schematic illustration of the individual modules which form a first external shape of the control element according to the invention;

FIG. 4 is a schematic illustration of the individual modules which form a second external shape of the control element according to the invention;

FIG. 5 is a schematic illustration of the individual modules which form a third external shape of the control element according to the invention; and

FIG. 6 is a schematic illustration of the individual modules which form a fourth external shape of the control element according to the invention.

### DETAILED DESCRIPTION OF THE DRAWINGS

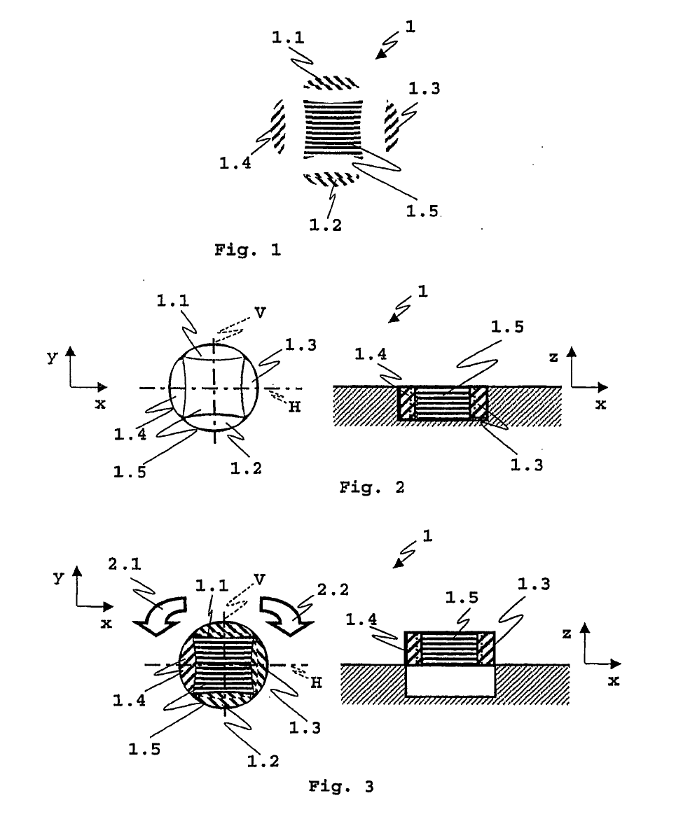

As is apparent from FIG. 1, the control element 1 in the illustrated exemplary embodiment includes four identical edge modules 1.1 to 1.4 and one central individual module 1.5 which can be raised and/or lowered in the positive and/or negative z direction of an xyz coordinate system as a function of the context. In FIG. 1, the positive z direction runs perpendicularly to the plane of the drawing and emerges from it, and the negative z direction enters the plane of the drawing. The modules 1.1 to 1.5 are actuated, for example, by an evaluation and control unit (not illustrated) as a function of the control element context. The control element 1 which can be assembled from the illustrated individual modules 1.1 to 1.5 has, for example, the degrees of freedom of adjustment: rotation in the clockwise direction 2.2 and/or in the counterclockwise direction 2.1 about the z axis of the xyz coordinate system, horizontal sliding 3.2, 3.4 in a positive and/or negative x direction of the xyz coordinate system, and a vertical sliding 3.1, 3.3 in a positive and/or a negative y direction of the xyz coordinate system. Individual modules 1.1 to 1.5 of the control element are arranged such that the control element 1 is mirror-symmetrical with respect to a vertical and/or a horizontal central axis V, H.

The method of functioning of the control element 1 according to the invention will be described below with reference to FIGS. 2 to 6. Each of FIGS. 2 to 6 shows two schematic illustrations of the control element 1, the left-hand illustrations of which show a plan view of the control element 1, and the right-hand illustrations of which show a sectional illustration of the control element 1 along the horizontal central axis H. In the respective plan view in FIGS. 2 to 6, the individual modules 1.1 to 1.5 which are illustrated by hatching show that these individual modules 1.1 to 1.5 have moved from the initial position in the positive z direction, i.e., out of the plane with the drawing, into an end position. This is in turn apparent from the associated sectional illustrations.

FIG. 2 shows the control element 1 in a position of rest in which all the individual modules 1.1 to 1.5 are lowered into the initial position.

If the control element context requires, for example, a rotary actuator for corresponding analog settings such as volume, base, treble, etc., all the individual modules 1.1 to 1.5 are, as is illustrated in FIG. 3, raised from the initial position in the positive z direction into the illustrated end position, with only the degrees of freedom of adjustment 2.1 and 2.2 of the control element being enabled 1, which permit a rotational movement in the clockwise direction or in the counterclockwise direction about the z axis of the xyz coordinate system. The other degrees of freedom of adjustment 3.1 to 3.4 of the control element 1 are disabled. As is further apparent from FIG. 3, the control element 1 assumes the cylindrical shape of a rotary actuator by virtue of the specific shape of the individual modules 1.1 to 1.5, the cylindrical shape being ergonomically optimum for a rotational movement and being recognizable by the user.

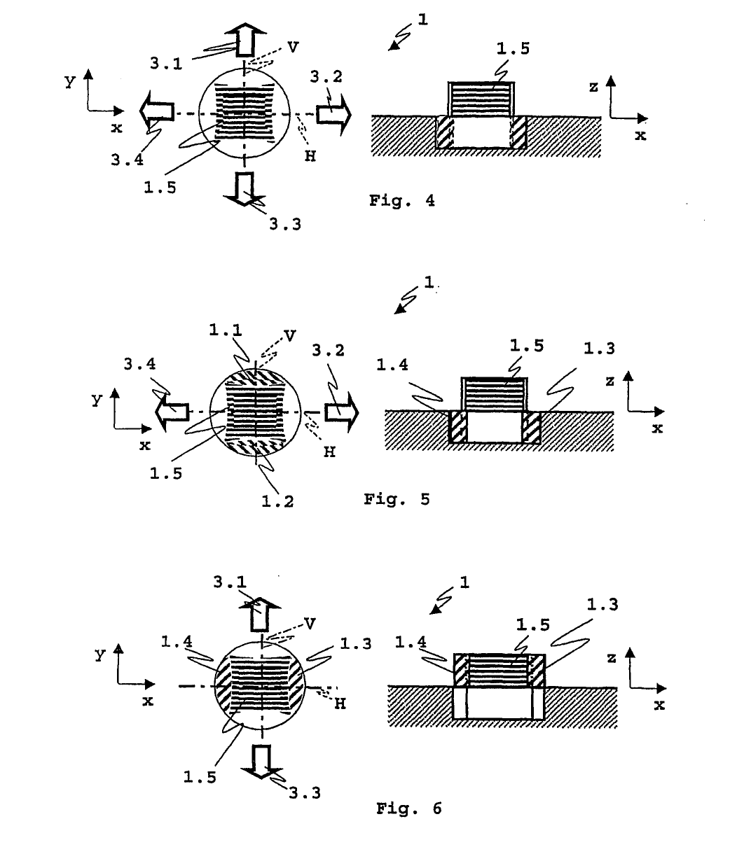

If the control element context requires, for example, a four-direction switch, as is illustrated in FIG. 4, only the central individual module 1.5 of the control element 1 is raised from the initial position in the positive direction into the end position. The other individual modules 1.1 to 1.4 are lowered in the initial position, the horizontal and the vertical sliding movements 3.1 to 3.4 of the control element 1 being enabled, and the rotational movements 2.1, 2.2 of the control element 1 being disabled. As is further apparent from FIG. 4, the central individual module 1.5 has a recess on each of its four side faces, each of which recesses has an ergonomically optimum shape for the sliding movement in the direction of the recess. In addition, by virtue of the recesses, the possible sliding movements for the user can be recognized. The shape illustrated in FIG. 4 for the control element 1 thus supports in an optimum way the four sliding movements of the four-direction switch which is necessary according to the control element context.

If the control element context requires, for example, a sliding switch for horizontal sliding movements 3.2, 3.4, the individual modules which are arranged along the vertical central axis V, i.e., the edge module 1.1 illustrated at the top in FIG. 5, the central individual module 1.5 and the edge module 1.2 (illustrated at the bottom in FIG. 5) of the control element 1 are raised from the initial position in the positive z direction into the end position. The other edge modules 1.3 and 1.4 are lowered in the initial position, with only the horizontal sliding movements 3.2 and 3.4 of the control element 1 being enabled and the rotational movements 2.1, 2.2 and the vertical sliding movements 3.1, 3.3 of the control element 1 being disabled.

As is further apparent from FIG. 5, the illustrated control element 1 has a recess on each of its left-hand and right-hand side faces, the recesses corresponding to those in the central individual module 1.5 and being each shaped in an ergonomically optimum way for the sliding movement in the direction of the recess and thus for horizontal sliding movements 3.2, 3.4. The recesses on the upper and lower side faces of the central individual module 1.5 are filled by the edge modules 1.1 and 1.2, so that in each case a bulge is produced and the vertical extent of the control element 1 is greater than the horizontal extent. As a result, possible sliding movements 3.2 and 3.4 can be recognized by the user. This shape (illustrated in FIG. 5) of the control element 1 thus supports in an optimum way the two horizontal sliding movements 3.2 and 3.4 of the horizontal sliding switch which is necessary according to the control element context.

If the control element context requires, for example, a sliding switch for vertical sliding movements 3.1, 3.3, the individual modules which are arranged along the horizontal central axis H, i.e., the edge module 1.4 which is illustrated on the left in FIG. 6, the central individual module 1.5 and the edge module 1.3 (illustrated on the right in FIG. 6) of the control element 1 are raised from the initial position in the positive z direction into the end position. The other edge modules 1.1 and 1.2 are lowered in the initial position, with only the vertical sliding movements 3.1 and 3.3 of the control element 1 being enabled and the rotational movements 2.1, 2.2 and the horizontal sliding movements 3.2, 3.4 of the control element 1 being disabled.

As is further apparent from FIG. 6, the illustrated control element 1 has a recess on each of its upper and lower side faces, the recesses corresponding to those in the central individual module 1.5 and each having an ergonomically optimum shape for the sliding movement in the direction of the recess and thus for vertical sliding movements 3.1, 3.3. The recesses on the left-hand and right-hand side faces of the central individual module 1.5 are filled by the edge modules 1.3 and 1.4 so that in each case a bulge is produced and the horizontal extent of the control element 1 is greater than the vertical extent. As a result, the possible sliding movements 3.1, 3.3 can be recognized by the user. The shape (illustrated in FIG. 6) of the control element 1 thus supports in an optimum way the two vertical sliding movements 3.1 and 3.3 of the vertical sliding switch which is necessary according to the control element context.

In the control element according to the invention, the degrees of freedom of adjustment which are present are enabled and/or disabled as a function of the context, and the external shape of the control element is adapted to the enabled degrees of freedom of adjustment, i.e., the control element looks, according to requirements, like a rotary switch and/or a four-direction switch and/or a horizontal and/or a vertical sliding switch. As a result, the possible degrees of freedom of adjustment of the control element can be clearly seen or felt, permitting intuitive and reliable operation of the control element even without visual contact.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A control element for a vehicle, comprising:
a plurality of individual modules configured to change the shape of the control element as a function of context; wherein,
said plurality of modules include a plurality of degrees of freedom of adjustment which are enabled or disabled as a function of the control element context;
the shape of the control element is adaptable to the enabled degrees of freedom of adjustment of the control element by raising or lowering at least one of the individual modules.

12. The control element as claimed in claim 11, wherein:
raising of the individual modules occurs in a positive z direction of an xyz coordinate system; and
lowering of the individual modules occurs in a negative z direction of the xyz coordinate system.

13. The control element as claimed in claim 11, wherein the plurality of degrees of freedom of adjustment permit the following types of activation of the control element:
a rotational movement in the clockwise direction about the z axis of the xyz coordinate system;
a rotational movement in the counterclockwise direction about the z axis of the xyz coordinate system;
a horizontal sliding movement in the positive or negative x direction of the xyz coordinate system; and
a vertical sliding movement in the positive or negative y direction of the xyz coordinate system.

14. The control element as claimed in claim 11, wherein the control element includes a central individual module and four identically shaped edge modules.

15. The control element as claimed in claim 14, wherein the individual modules are arranged such that the control element is mirror-symmetrical with respect to a vertical or horizontal central axis.

16. The control element as claimed in claim 11, wherein a first external shape of the control element is adapted to rotational movements of the control element, with all the individual modules being moved from an end position, and forming a round rotary actuator, and with the rotational movements of the control element being enabled and vertical and horizontal sliding movements of the control element being disabled.

17. The control element as claimed in claim 11, wherein a second external shape of the control element is adapted to vertical sliding movements of the control element, with the individual modules of the control element which are arranged along the horizontal central axis being moved from an initial position in the positive z direction into an end position and forming a sliding switch, and with the vertical sliding movements being enabled and horizontal sliding movements and rotational movements of the control element being disabled.

18. The control element as claimed in claim 11, wherein a third external shape of the control element is adapted to horizontal sliding movements of the control element, with the individual modules of the control element which are arranged along the vertical central axis being moved from an initial position in the positive z direction into an end position and forming a sliding switch, and with the horizontal sliding movements being enabled and vertical sliding movements and rotational movements of the control element being disabled.

19. The control element as claimed in claim 11, wherein a fourth external shape of the control element is adapted to horizontal and vertical sliding movements of the control element, with a central individual module of the control element being moved from an initial position in the positive z direction into an end position and forming a four-direction switch, and with the horizontal and the vertical sliding movements being enabled and rotational movements of the control element being disabled.

20. The control element as claimed in claim 11, wherein, in a position of rest of the control element, all of the individual modules are lowered into an initial position.

21. The control element as claimed in claim 12, wherein the plurality of degrees of freedom of adjustment permit the following types of activation of the control element:
a rotational movement in the clockwise direction about the z axis of the xyz coordinate system,
a rotational movement in the counterclockwise direction about the z axis of the xyz coordinate system,
a horizontal sliding movement in the positive or negative x direction of the xyz coordinate system, and
a vertical sliding movement in the positive or negative y direction of the xyz coordinate system.

22. The control element as claimed in claim 12, wherein the control element includes a central individual module and four identically shaped edge modules.

23. The control element as claimed in claim 13, wherein the control element includes a central individual module and four identically shaped edge modules.

24. The control element as claimed in claim 22, wherein the individual modules are arranged such that the control element is mirror-symmetrical with respect to a vertical or horizontal central axis.

25. The control element as claimed in claim 23, wherein the individual modules are arranged such that the control element is mirror-symmetrical with respect to a vertical or horizontal central axis.

26. The control element as claimed in claim 14, wherein a first external shape of the control element is adapted to rotational movements of the control element, with all the individual modules being moved from an end position, and forming a round rotary actuator, and with the rotational movements of the control element being enabled and vertical and horizontal sliding movements of the control element being disabled.

27. The control element as claimed in claim 14, wherein a second external shape of the control element is adapted to vertical sliding movements of the control element, with the individual modules of the control element which are arranged along the horizontal central axis being moved from an initial position in the positive z direction into an end position and forming a sliding switch, and with the vertical sliding movements being enabled and horizontal sliding movements and rotational movements of the control element being disabled.

28. The control element as claimed in claim 14, wherein a third external shape of the control element is adapted to horizontal sliding movements of the control element, with the individual modules of the control element which are arranged along the vertical central axis being moved from an initial position in the positive z direction into an end position and forming a sliding switch, and with the horizontal sliding movements being enabled and vertical sliding movements and rotational movements of the control element being disabled.

29. The control element as claimed in claim 14, wherein a fourth external shape of the control element is adapted to horizontal and vertical sliding movements of the control element, with a central individual module of the control element being moved from an initial position in the positive z direction into an end position and forming a four-direction switch, and with the horizontal and the vertical sliding movements being enabled and rotational movements of the control element being disabled.

30. A control element for performing a plurality of control movements, wherein:
said control element is configured to assume a plurality of shapes;
each shape of said control element shapes corresponds to a different control movement;
when said control element is in a particular shape, only a control movement corresponding to said particular shape is enabled.
